(19) United States
(12) Patent Application Publication
(10) Pub. No.: US 2019/0368463 A1
(43) Pub. Date: Dec. 5, 2019

(54) SYSTEM AND METHOD OF HARNESSING ENERGY WITH A NON-BUOYANT OBJECT AND A BUOYANT OBJECT

(71) Applicant: Thomas Farrell Desormeaux, JR., New Orleans, LA (US)

(72) Inventor: Thomas Farrell Desormeaux, JR., New Orleans, LA (US)

(21) Appl. No.: 16/435,316

(22) Filed: Jun. 7, 2019

Related U.S. Application Data
(63) Continuation-in-part of application No. 62/677,445, filed on May 29, 2018.

(51) Int. Cl. F03B 17/04

(52) U.S. Cl. CPC F03B 17/04; F05B 2260/503; F05B 2220/706; F05B 2210/404

(57) ABSTRACT

A system of harnessing energy with a non-buoyant object and a buoyant object that captures the potential energy of a weight as it falls through a fluid such as water and then attaches a float to the weight to return it to the origin via the differential in densities thereof. The exemplary fluid used is water and that of oceans or lakes. The floats are deposited near the bottom of the ocean or lake by way of a tube or other passageway.

### BACKGROUND

### 1. Field of the Invention

The present invention relates to harnessing energy with an object denser or heavier than water and this object is cycled using buoyancy and gravity.

### 2. Description of Related Art

Power generation systems are well known in the art and are effective means to change one form of energy to another as examples chemical to electrical or electrical to mechanical. Many methods of creating large amounts of electricity include turbines that are driven by steam or combusted gas. These turbines require the use of fuels such as coal, fossil fuels or nuclear material. These fuels are limited in quantity and if they are continually used will be depleted. Additionally, the use of these fuels results in unwanted waste material such as carbon released to the atmosphere or nuclear waste that must be stored for hundreds of years.

Many attempts have been made to harness other sources of energy such as solar radiation, wind movement and hydroelectric. These sources have developed but have not been able to efficiently replace the use of fuels in power generation.

Efforts in the area of hydroelectric power generation include the capture of both the potential and kinetic energy of rivers flowing downhill or from the movement of ocean water from tides or currents. These efforts also have significant limitations both from technological and environmental restrictions.

Accordingly, although great strides have been made in the area of power generation systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a system of harnessing energy with a non-buoyant object and a buoyant object in accordance with a preferred embodiment of the present application;

FIGS. 2A, 2b and 2C are side views of the system of FIG. 1 in use;

FIG. 3 is a side view of an embodiment of the float of FIG. 1;

FIG. 4 is a side view of an embodiment of the weight of FIG. 1

FIG. 5 is a front view of an alternative embodiment of the system of FIG. 1

FIG. 6 is a cross-sectional front view of the float of FIG. 5;

FIG. 7 is a simplified schematic of the power system of the float of FIG. 6; and

FIG. 8 is a front view of an alternative embodiment of the system of FIG. 5.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional power generation systems. Specifically, the invention of the present application does not require the use of fuel to create a constant source of energy. In addition, the impact of the system on the geographic area is small and can be mitigated to lessen the impact on the environment. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

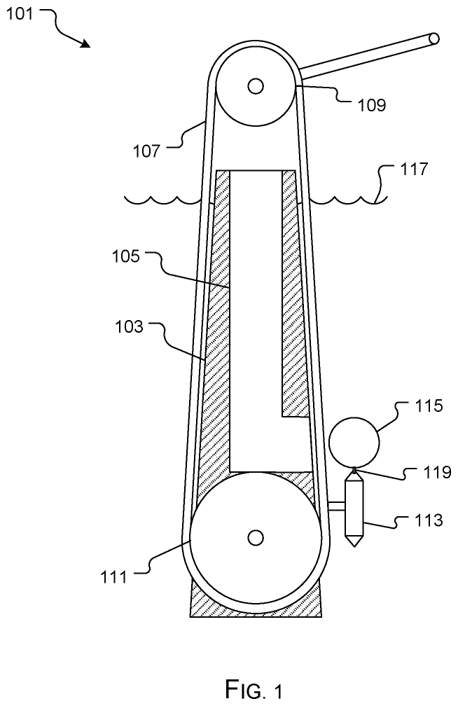

Referring now to the drawings wherein like reference characters identify corresponding or similar elements throughout the several views, FIG. 1 depicts a side view of a system of harnessing energy with a non-buoyant object and a buoyant object in accordance with a preferred embodiment of the present application. It will be appreciated that system 101 overcomes one or more of the above-listed problems commonly associated with conventional power generation systems.

In the contemplated embodiment, system 101 includes tube 103 having a passageway 105 therein. The system 101 also includes a cable 107 or some other pliable member such as a chain or the like between a first wheel 109 and a second wheel 111 in proximity to the tube 103. Weights 113 are attached to the cable 107 and allowed to sink in a body of water 117. The weights 113 are configured to attach to a float 115 via a fastener 119. The passageway 105 having an opening above the surface of the water 117 and a below near the second wheel 111.

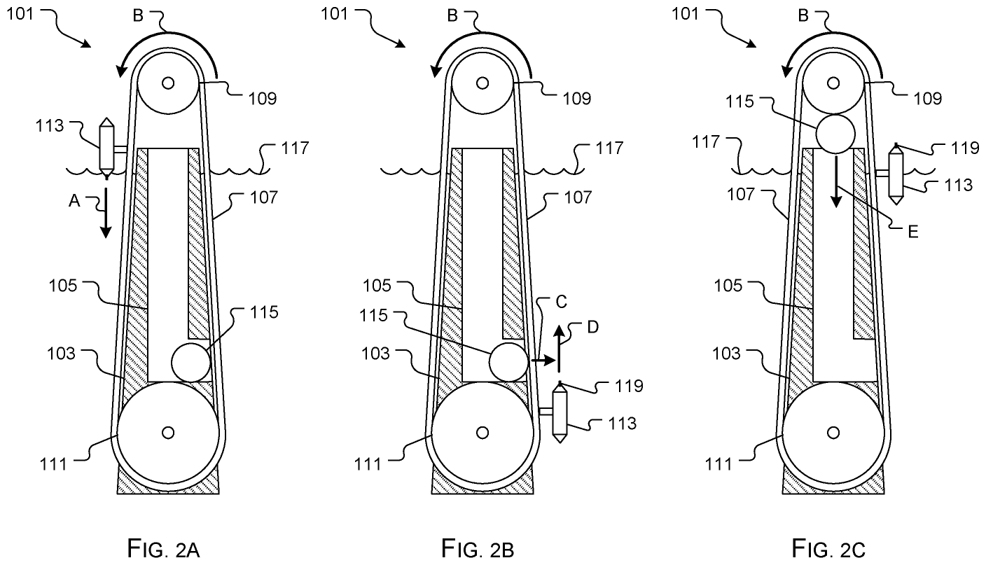

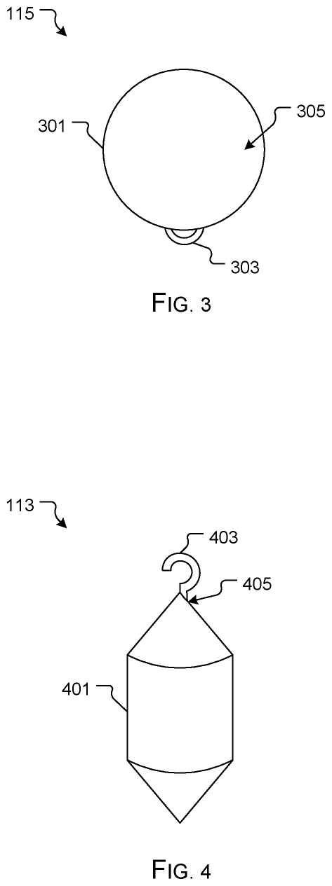

In use, as depicted by FIGS. 2A, 2B and 2C the cable 107 has a weight attached above the surface of the body of water 117 and moves as depicted by motion A via the force of gravity toward the second wheel 111 causing the wheels 109, 111 to rotate as depicted by motion B and turn an electric motor or the like to generate electricity. When the weight reaches the bottom near the second wheel 111 a float 115 exits the tube 103 as depicted by motion C and is attached to the weight 113 causing it to float upward as depicted by motion D via the difference in density. This force returns the weight 113 to the surface where the float 115 is removed and the weight 113 allowed to fall as depicted by motion E. The removed float 115 enters the passageway and falls down to be re-attached to the weight 113.

It is contemplated that the passageway 105 will have the means of allowing the floats 115 to transit therein. This could include the geometry of the openings, valves, pressure chamber and the like so long as the floats 115 are moved from the surface of the water 117 down to the second wheel 111 where they are attached to the weights 113.

While a single weight 113 and float 115 are depicted for clarity, it is contemplated that many weights and floats would be used in the system.

It should be appreciated that one of the unique features believed characteristic of the present application is that gravity and density are used in conjunction to create a constant source of power generation. It will also be appreciated that the system is able to be used in any body of water such as the ocean, a lake or groundwater so long as the floats are able to be lifted by the differential in their density and that of water.

It is also contemplated that any fluid could be used in a controlled environment and that water is used as an example because of its ready availability in mass quantities. It will be appreciated that the fluid could be air.

Referring now to FIG. 3 a preferred embodiment of the float 115 is depicted. The float 115 including a body 301 having a connecting device 303 attached to the outer surface 305 thereof.

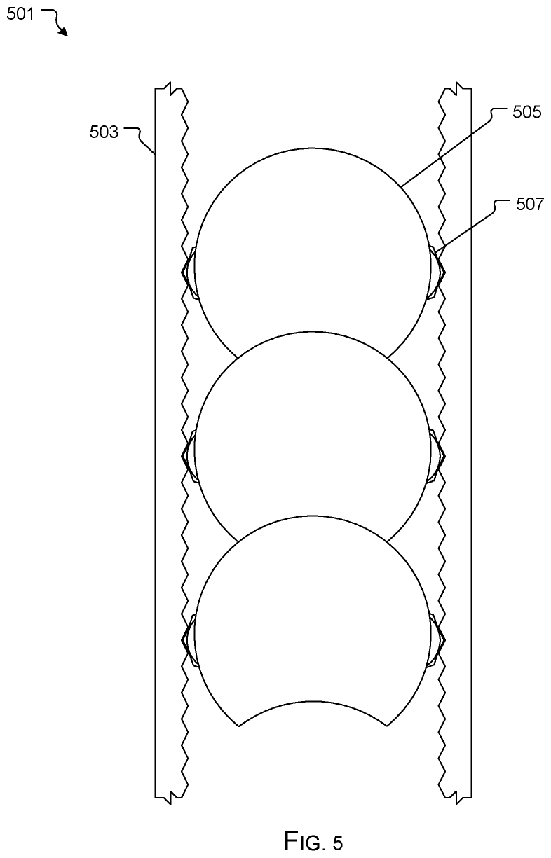

Referring now to FIG. 4 a preferred embodiment of the weight 113 is depicted. The weight 113 having a low resistance body 401 with a connecting device 403 attached to a first end 405 thereof. It is contemplated that the connecting device 303 and 403 will join together to enable the float 115 to attach to the weight 113.

While a hook is depicted as connecting device 303 and a hook as connecting device 403 any method of connecting float 115 to weight 113 is contemplated and that these examples should be interpreted as limiting the application of the present invention is scope.

It is also contemplated and will be appreciated that while a single float 115 has been depicted as attached to weight 113 that multiple floats 115 could be attached to a single weight 113 to increase the force on the weight causing it to rise.

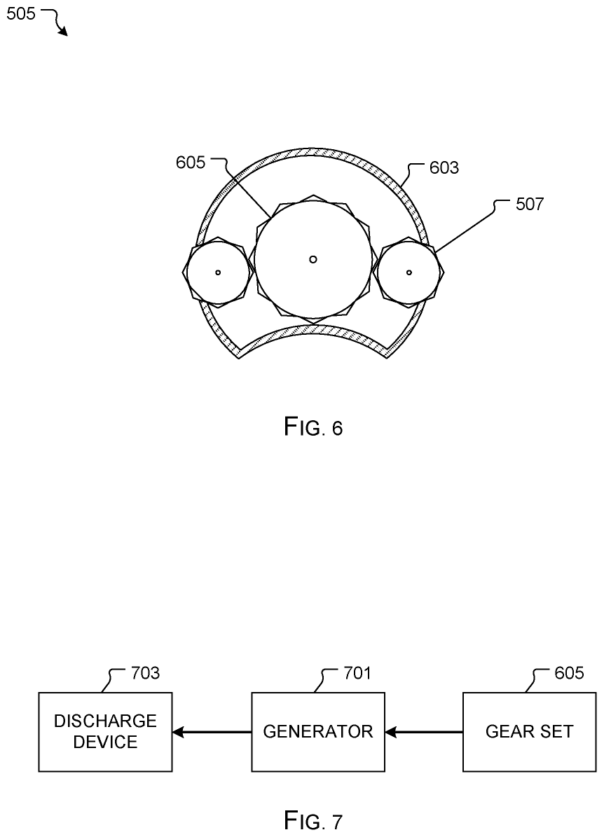

Referring now to FIG. 5 an alternative embodiment of the system 101 is depicted. Embodiment 501 includes a set of geared tracks 503 in communication with floats 505. Each float having multiple gear wheels 507 that interact and travel along the set of geared tracks 503. It is contemplated that as the floats 505 rise through the water by the buoyant force that the gear wheels 507 will rotate.

It is contemplated that the floats 505 are configured to ensure alignment of thereof, one above another, as they travel along the geared tracks 503

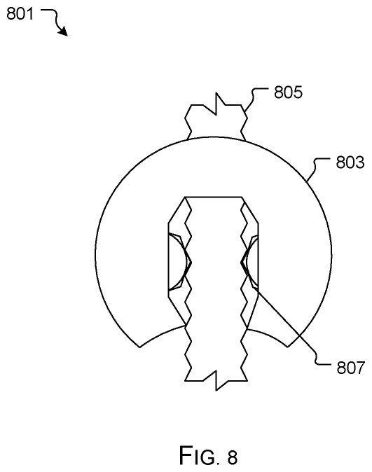

It is further contemplated as depicted by FIG. 6 that the float 505 includes a housing 603 that prevents water from entering the float 505. The gear wheels 507 protrude from the housing 603. Inside the housing 603, the gear wheels 507 rotate a gear set 605 that is connected to a shaft. As depicted by FIG. 7 the gear set 605 is in rotational communication with a generator 701 that is configured to produce and store electricity to leave the float 505 via a discharge device 703. It is contemplated that this would occur out of the water but that it could occur continuously as well.

Referring now to FIG. 8 an alternative embodiment of the system 501 is depicted. Embodiment 801 includes floats 803 configured to travel along a geared shaft 805. In this embodiment, 801 the gear wheels 807 are configured to interact and travel along the geared shaft 805.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A system of harnessing energy with a non-buoyant object and a buoyant object comprising:
a tube having a passageway disposed of therein;
a first wheel and at least a second wheel in rotational communication via a pliable member;
at least one weight; and
at least one float;
wherein power is generated via the rotation of the first wheel or second wheel;
wherein the weight is allowed to descend through a fluid; and
wherein at least one float is attached thereto via the passageway to force the weight to ascend through the fluid.

2. The system of claim 1 wherein the float is of lesser density than the fluid causing it to be buoyant therein.

3. The system of claim 1 wherein the weight is of greater density than the fluid causing it to be non-buoyant therein.

4. The system of claim 1 wherein the float and weight attach via connection devices.

5. The system of claim 1 wherein the floats travel through the passageway via gravity.

6. The system of claim 1 wherein the fluid is an ocean, lake, or another body of water such as a well.

7. The system of claim 1 wherein the fluid is air.
